(19) United States
(12) Patent Application Publication
(10) Pub. No.: US 2017/0045161 A1
(43) Pub. Date: Feb. 16, 2017

(54) MULTILAYER COMPOSITE WASTE TUBE

(71) Applicant: RAMPF Composite Solutions Inc., Burlington (CA)

(72) Inventors: Gerry KAVANAUGH, Burlington (CA); Joerg WIEBE, Ft. Myers, FL (US)

(21) Appl. No.: 15/307,215

(22) PCT Filed: Apr. 30, 2015
(86) PCT No.: PCT/CA2015/000287

§ 371 Date: Oct. 27, 2016

Related U.S. Application Data
(60) Provisional application No. 61/987,059, filed on May 1, 2014.

(51) Int. Cl. F16L 9/12; E03F 3/04; F16L 57/06

(52) U.S. Cl. CPC F16L 9/123; F16L 57/06; E03F 3/04

(57) ABSTRACT

According to the present invention, a waste tube with component layers is provided. An inner layer resisting at least one waste material system chemical and an outer composite wrapping layer each runs along the length of the waste tube. The impact zones of the waste tubes, defined by bends, tapers or junctions incorporated in the tube, are reinforced by an elastomeric barrier layer over an outer face of the inner layer and an impact absorption layer over the elastomeric barrier layer, wrapped by the outer composite layer. In another aspect, a method of manufacturing the waste tube is provided where a preformed tubular liner for building the component layers functions as the inner layer in the waste tube.

### FIELD OF INVENTION

This invention relates to waste tubes. More particularly, this invention relates to waste tubes in a pressure-driven system with waste, drain, vent and air application.

### BACKGROUND OF THE INVENTION

Waste tubes, once installed in a pressure-driven system such as in an aircraft or modern trains, are not expected to be removed or otherwise repaired. Accordingly, these waste tubes must withstand significant biological waste, chemical activity, and pressure-driven debris that travels through the tube. Particularly in aircraft systems, these waste tubes must withstand such potentially destructive effects for the life of the aircraft and satisfy safety of flight requirements such as requirement in case of fire. Because of the wastes and materials traveling within the waste tube, these waste tubes are subject to bio-film build up and chemical or corrosive activity along the length of the tubes.

In particular, because of the use of a vacuum system to suction waste to its desired endpoint, waste tubes are vulnerable to breach by vacuum-pressure driven debris at impact zones, defined by bends, tapers or junctions incorporated in the tubes. For example, a hard object not intended to travel within the waste tube such as a battery can become a projectile. The projectile may generally harmlessly travel the length of a straight tube but can breach the tube at impact such as where the tube is angled or bent or tapered. The projectile may alternatively breach an impact zone defined by the junction or pullout region of the tube.

Presently, generally wholly titanium tubes are used for such pressure-driven waste systems. These tubes are fairly resistant to corrosion and chemicals and are also generally resistant to breach caused by vacuum pressure-driven debris. Thin walled metal tubes, such as titanium tubes, are also formable (i.e., for welding, bending, and fabricating). They additionally provide some resistance to bio-film build-up and can be generally damage resistant for the life of the aircraft. However, these tubes are expensive, labor intensive, and have a greater weight than is otherwise desirable. Thus, it is desirable to create a waste tube that may be less expensive, require less labor, and/or have a reduced weight when compared to conventional waste tubes.

### SUMMARY OF THE INVENTION

According to one aspect of the present disclosure, a waste tube defining a passage therethrough for carrying waste material and projectiles in a pressurized system is provided. The waste tube has a series of component layers comprising an inner layer that is resistant to at least one waste system chemical. The inner layer defines an interior tubular surface of the waste tube and resists bio-film build-up of waste material flowing within the waste tube either inherently or through additives.

An outer composite wrapping layer defines an exterior tubular surface of the waste tube for wrapping the remaining component layers.

An elastomeric barrier layer optionally rests therebetween on at least one impact zone defined by bends, tapers or junctions of the tube for providing shock damping, distribution and absorption of projectile impacts and further presenting a leakage barrier against waste material and projectiles traveling within the waste tube. An impact absorption layer rests between the elastomeric barrier layer and the outer composite wrapping layer for absorbing the impact of projectiles and as an additional leakage barrier on the at least one impact zone.

In another aspect of the present disclosure, a method of manufacturing such a waste tube is provided. A preformed tubular liner defining a passage is provided comprising a material resistant to at least one waste system chemical wherein the preformed tubular liner functions as a support layer for other layers added over it and is an inner layer for the waste tube.

An elastomeric barrier layer is added over an outer face of the preformed tubular liner on at least one impact zone defined by bends, tapers or junctions of the preformed tubular liner. An impact absorption layer is placed over the elastomeric barrier layer for absorbing the impact of projectiles. The component layers are wrapped with an outer composite wrapping layer for providing an exterior tubular surface of the waste tube.

### BRIEF DESCRIPTION OF THE DRAWINGS

These and other features of the invention will become more apparent from the following description in which reference is made to the appended drawings wherein:

FIG. 1 is a perspective partially cut away view of an exemplary tube having a bend;

FIG. 1A is an enlargement of the encircled portion A of FIG. 1;

FIG. 1B is an enlargement of the encircled portion B of FIG. 1;

FIG. 2 is a perspective partially cut away view of an exemplary tube having a junction;

FIG. 2A is an enlargement of the encircled portion A of FIG. 2;

FIG. 3A is a partially cut away view of an exemplary tube end with the inner layer in a closed configuration;

FIG. 3B is a partially cut away view of an exemplary tube end with the inner layer in a flush configuration; and

FIG. 3C is a partially cut away view of an exemplary tube with the inner layer in a bent configuration.

FIG. 3D is a partially cut away view of an exemplary tube with the inner layer in an encapsulated configuration.

### DETAILED DESCRIPTION

One or more currently preferred embodiments have been described by way of example.

One aspect of the present invention provides a waste tube, indicated generally by the reference numeral 100 in the accompanying figures, defining a passage 106 therethrough for carrying waste material and projectiles in a pressurized system. The waste tube 100 may be straight or incorporate bends, angles, tapers or junctions such as manifolds, pullouts, tees and wyes. The waste tube 100 may also be any suitable circumference as well as any suitable cross-section to carry waste substances. Examples are symmetrical shapes such as circular, edged and elliptic forms, or asymmetric shapes.

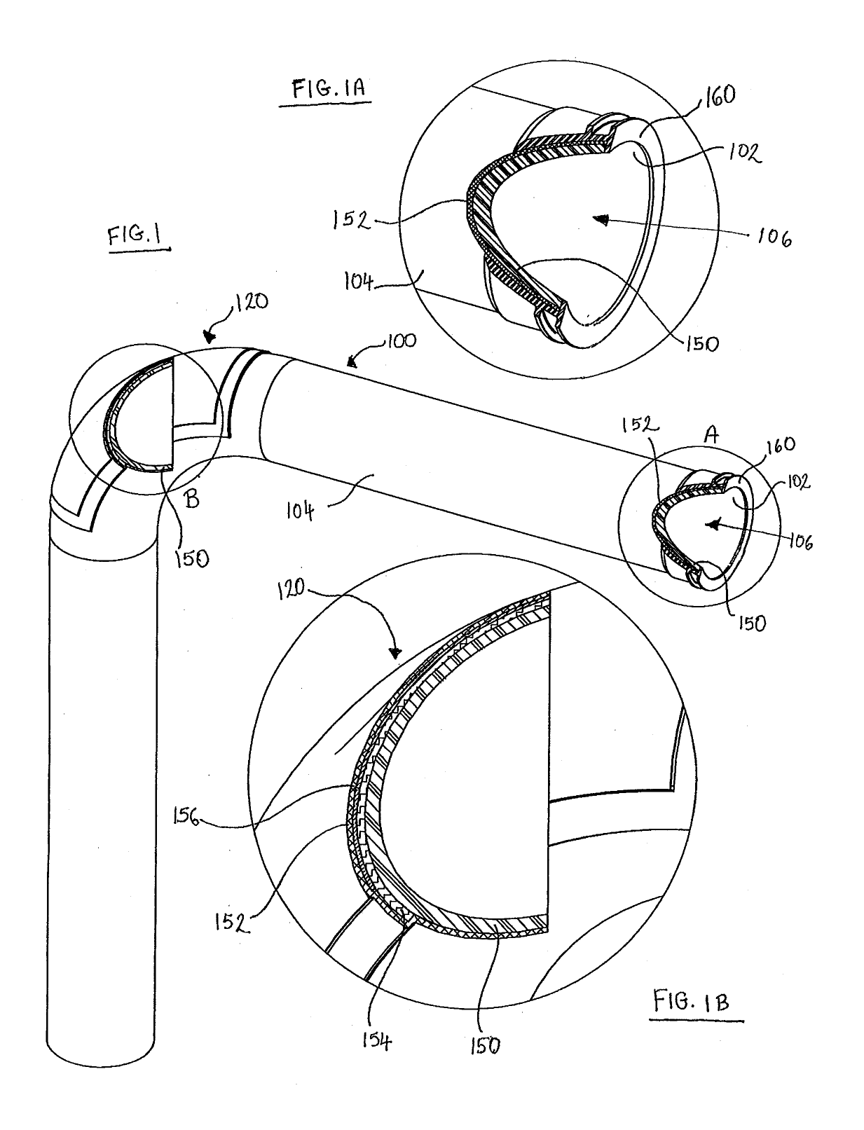

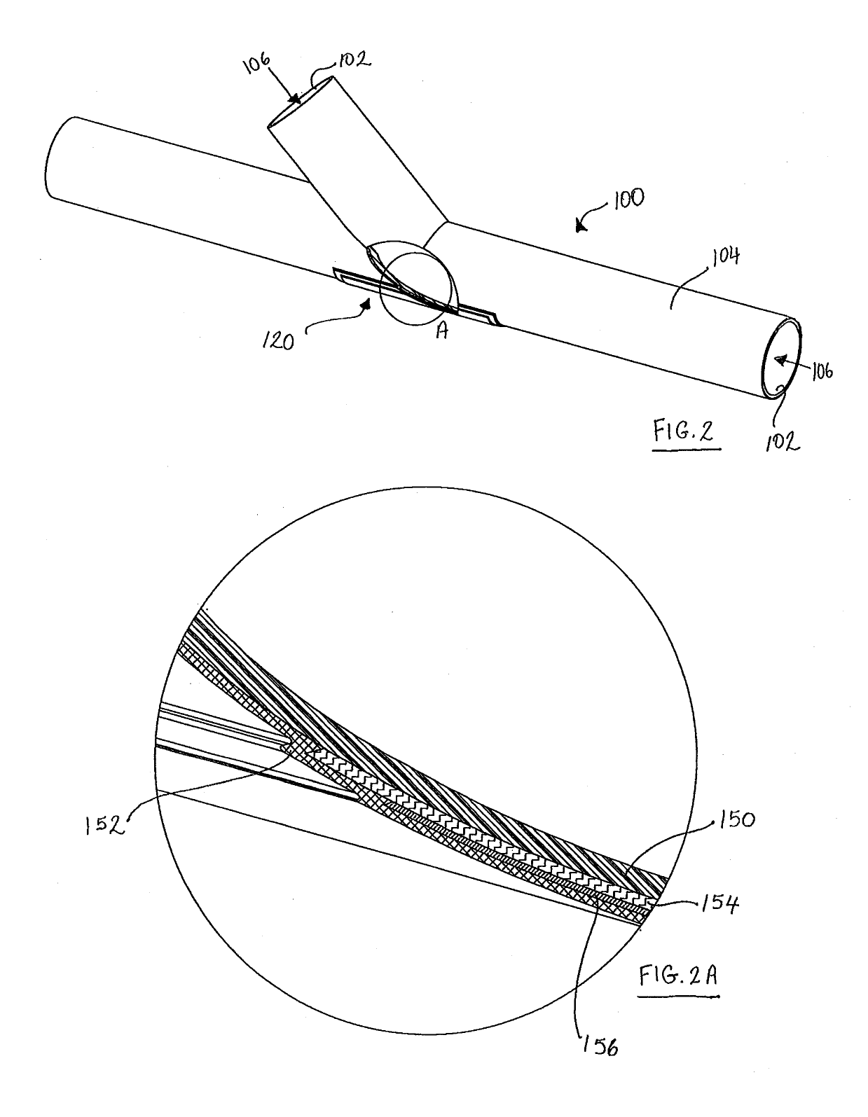

In the illustrated embodiments, the exemplary waste tube 100 is shown as a cylindrical tube. FIG. 1 illustrates a waste tube 100 incorporating a bend and having a generally circular cross-section. FIG. 2 illustrates a waste tube 100 incorporating a junction or pullout along with a generally circular cross-section. The regions incorporating the bend and the junction are illustrated as impact zones 120.

The waste tube 100 is comprised of a series of component layers. The innermost layer of the tube is an inner layer 150 resistant to at least one waste system chemical. Defining the interior tubular surface 102 of the waste tube 100, the inner layer 150 limits the build-up of bio-film either inherently or through the use of additives and generally resists the chemical activity of material traveling within the waste tube 100 that can otherwise damage or cause leakage through the waste tube 100. This inner layer 150 may be a thermoplastic layer that resists various industrial chemicals and solvents as well provides resistance to bio-film build-up. This chemical and bio-film resistant property of the inner layer 150 permits the waste tube 100 to carry waste materials within its passage 106 while limiting the build-up of bio-film resulting from such waste substances. It also resists breach by various other chemical compositions that travel through the waste tube 100. Examples of thermoplastics that may be used to line the interior of the waste tube 100 include fluoropolymers that are thermoformable such as polytetrafluoroethylene (PTFE), fluorinated ethylene propylene (FEP), High and Medium Density Polyethylene (HDPE, MDPE), Cross-link Polyethylene (XLPE or PEX), and perfluoroalkoxy (PFA) among others. The inner layer 150 may additionally be polyamide (nylon), acrylonitrile butadiene styrene (ABS), Polyvinylidene Difluoride (PVDF) or combinations thereof. Such combinations could be co-extruded or otherwise formed. Other examples include: PVC, CPVC, EFEP, etc. The inner layer 150 may also be a thermoset plastic layer, such as PEEK, PEI, etc.

The outermost layer of the waste tube 100 is an outer composite wrapping layer 152 defining the exterior tubular surface 104 of the waste tube 100. This outer composite wrapping layer 152 wraps the remaining component layers. The composite wrapping layer 152 could be, for example, a carbon fiber epoxy, fiberglass, or Aramid fiber among others, such as Dyneema, S-Glass, S2-Glass, Spectra, or any other suitable material known to one skilled in the art,. This outer composite layer 152 functions as a sleeve to wrap the remaining component layers of the tube 100. This layer, such as carbon fiber epoxy can impart mechanical strength and withstand temperature fluctuations among other desirable properties. It also functions as a secondary leakage barrier. Other composites known to one skilled in the art may also be used for the outer composite wrapping layer 152.

While the inner layer 150 and the outer composite wrapping layer 152 run along the entire length of the waste tube 100, the impact zones 120 are reinforced with additional layers. Thus, the inner layer 150 and outer composite layer 152 register with each other along much of the waste tube 100 but are separated along the impact zones 120 by reinforcing layers.

An elastomeric barrier layer 154 optionally rests between the inner layer 150 and the outer composite wrapping layer 152 at the impact zones 120. The elastomeric barrier layer 154 provides impact damping, distribution and absorption functionalities and represents an additional leakage barrier against waste material and projectiles that may travel within the passage 106 of the waste tube 100. In particular, as an unintended projectile, such as a battery, impacts the impact zone 120, the elastomeric barrier layer 154 damps, distributes and absorbs the stresses, and provides a barrier against leakage. The elastomeric barrier layer 154 may be Viton® rubber or silicone rubber or any other suitable elastomeric material known to one skilled in the art, and be variable in wall thickness depending on the application requirements.

An impact absorption layer 156 rests between the elastomeric barrier layer 154 and the outer composite wrapping layer 152 to reinforce the impact zone 120. The impact absorption layer 156 may be a metal patch such as stainless steel or titanium. The impact absorption layer 156 mainly absorbs the impact of any unintended projectiles, such as batteries or cell phones, along the radii of the bend or curve defining the impact zone 120 or along the linear portion of the tube 100 where a junction is incorporated. By absorbing the impact, the impact absorption layer 156 resists breach of the waste tube 100 at the impact zone 120. The metal patch may be of any suitable thickness that prevents breach of the waste tube 100, for example, between 0.001 and 0.100 inches.

The surface area occupied by the elastomeric barrier layer 154 may be the same (not shown) or greater than the surface area occupied by the impact absorption layer 156 (FIG. 1B). This coverage provided by the elastomeric barrier layer 154 to the impact absorption layer 156 limits the impact absorption layer's 156 contact with corrosive chemicals and waste materials that flow through any breach of the inner layer 150 resulting from the impact of a projectile at the impact zone 120. For example, Viton® rubber forming the elastomeric barrier layer 154 provides shock absorption and a leakage barrier against the potentially corrosive activity of chemicals carried in the waste stream that may otherwise reach the impact absorption layer 156 (e.g., titanium metal patch).

The reinforcement of impact zones 120 with an impact absorption layer 156 and an elastomeric barrier layer 154 advantageously limits the weight of such a waste tube 100. It may also reduce the overall cost of the waste tube 100.

Another aspect of the present invention provides a method of manufacturing such a waste tube as described above.

First, a preformed tubular liner defining a passage 106 is provided. The preformed tubular liner comprises a material resistant to at least one waste material system chemical, and the preformed tubular liner functions as an inner layer 150 for the waste tube 100 as well as a support layer for other layers described below. In this way, the preformed tubular liner need not be later dissolved or extracted but remains as an inner layer 150 of the waste tube 100.

An elastomeric barrier layer 154 is added over an outer face (not shown) of the preformed tubular liner and distal the passage 106. The elastomeric barrier layer 154 is added on at least one impact zone 120 defined by bends, tapers or junctions of the preformed tubular liner as described above. An impact absorption layer 156 is also added over the elastomeric barrier layer 154. An outer composite wrapping layer 152 is added for providing an exterior surface 104 of the waste tube 100. The inner layer 150 may be over molded with the outer composite wrapping layer 152 or it may be co-molded with the outer composite wrapping layer 152 and later bonded at the ferrules 160 placed at the tube ends. The use of ferrules 160 provides articulable connecting joints between adjacent waste tubes.

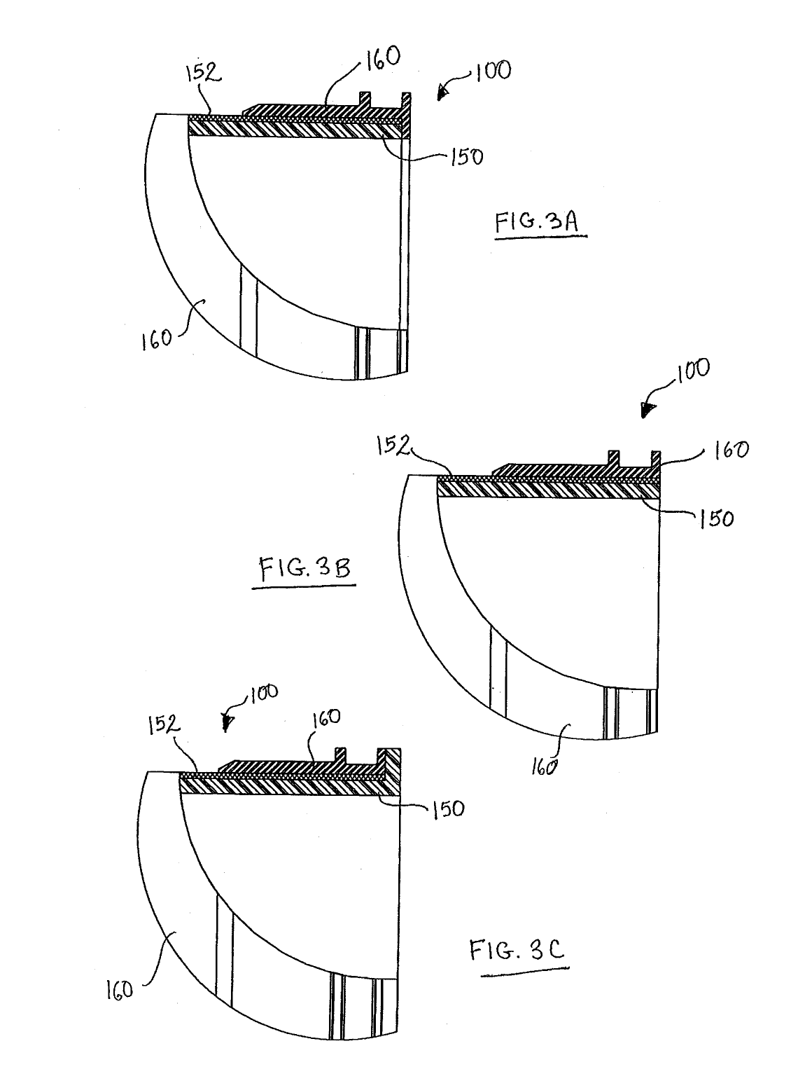

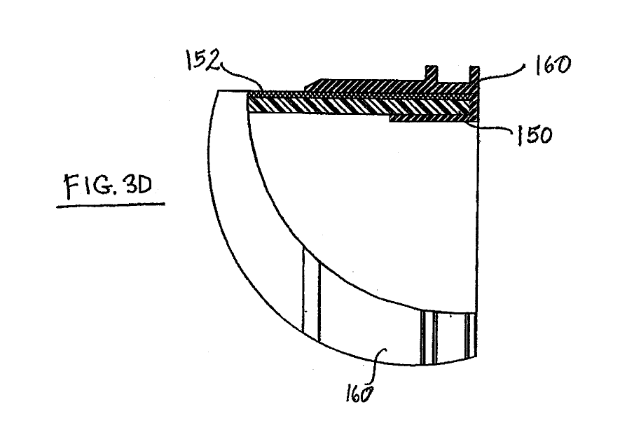

The inner layer 150 may be sealed at the ferrules 160, or at tube ends, in multiple ways. For example, as shown in FIG. 3A, the inner layer 150 may be in a closed configuration where the ferrule 160 extends over the inner layer 150. Alternatively, the inner layer 150 and ferrule 160 may be in flush configuration as shown in FIG. 3B. In still another alternative, the inner layer 150 may be folded to extend over the outer composite layer 152 as well as the ferrule 160 to create a bend configuration as in FIG. 3C. In another alternative, the inner layer 150 and composite wrapping layer 152 may be encapsulated by the ferrule as shown in FIG. 3D.

Although the above description relates to tubes for waste systems, it will be appreciated that such tubes may be used in other fluid carrying applications. Accordingly, the description should not be considered as limited to waste tube applications but should also be considered as applicable to conveying air and other materials.

The scope of the claims should not be limited by the preferred embodiments set forth in the examples, but should be given the broadest interpretation consistent with the description as a whole.

### PARTS LIST

100 waste tube
102 interior tubular surface
104 exterior tubular surface
106 passage
120 impact zone
150 inner layer
152 outer composite layer
154 elastomeric barrier layer
156 impact absorption layer
160 ferrule

1. A waste tube defining a passage therethrough for carrying waste material and potential projectiles in a pressurized system, said waste tube having a series of component layers, comprising:
an inner layer resistant to at least one waste system chemical defining an interior tubular surface of said waste tube for resisting bio-film build-up of material traveling within said passage of said waste tube;
an outer composite wrapping layer defining an exterior tubular surface of said waste tube for wrapping said component layers;
an elastomeric barrier layer optionally therebetween on at least one impact zone defined by bends, tapers or junctions of said tube for providing shock absorption and distribution, and leakage barrier against material and projectiles traveling within said passage of said tube; and
an impact absorption layer between said elastomeric barrier layer and said outer composite wrapping layer for the impact absorption of projectiles on said at least one impact zone.

2. The waste tube of claim 1, wherein said inner layer is a thermoplastic liner.

3. The waste tube of claim 2, wherein said thermoplastic liner is selected from the group consisting of: fluoropolymers that are thermoformable, High and Medium Density Polyethylene (HDPE, MDPE), Cross-link Polyethylene (XLPE or PEX) and perfluoroalkoxy (PFA)

4. The waste tube of claim 1, wherein said inner layer is a thermoset plastic liner.

5. The waste tube of claim 1, wherein said outer composite wrapping layer is selected from a group consisting of: carbon fiber, fiberglass, and Aramid fiber.

6. The waste tube of claim 1, wherein said elastomeric barrier layer is a rubberer.

7. The waste tube of claim 6 wherein said elastomeric barrier layer is selected from silicone rubber and Viton® rubber.

8. The waste tube of claim 1, wherein said impact absorption layer is a metal patch.

9. The waste tube of claim 8, wherein said metal patch comprises titanium.

10. The waste tube of claim 8, wherein said metal patch comprises stainless steel.

11. The waste tube of claim 8, wherein said metal patch is approximately 0.001-0.100 inches in thickness.

12. A method of manufacturing the waste tube of claim 1 comprising:
providing a preformed tubular liner defining a passage therethrough, said preformed tubular liner comprising a material resistant to at least one waste material system chemical wherein said preformed tubular liner functions as said inner layer for said waste tube;
adding said elastomeric barrier layer over an outer face of said pre-formed tubular liner on at least one impact zone defined by bends, tapers or junctions of said preformed tubular liner;
placing said impact absorption layer over said elastomeric barrier layer; and
wrapping said layers with said outer composite wrapping layer for providing an exterior surface of said waste tube.

13. A tube defining a passage therethrough for carrying at least one fluid and potential projectiles in a pressurized system, said tube having a series of component layers, comprising:
an inner layer resistant to said at least one fluid defining an interior tubular surface of said waste tube;
an outer composite wrapping layer defining an exterior tubular surface of said tube for wrapping said component layers;
an elastomeric barrier layer optionally therebetween on at least one impact zone defined by bends, tapers or junctions of said tube for providing shock absorption and distribution, and a leakage barrier against fluid and projectiles traveling within said passage of said tube; and
an impact absorption layer between said elastomeric barrier layer and said outer composite wrapping layer for the impact absorption of projectiles on said at least one impact zone.

14. (canceled)

15. The waste tube of claim 1, wherein said inner layer is selected from the group consisting of a polyamide, acrylonitrile butadiene styrene (ABS), Polyvinylidene Difluoride (PVDF), PVC, CPVC, EFEP and combinations thereof.

16. The waste tube of claim 1, wherein said inner layer is a thermoset plastic liner selected from PEEK and PEI.

17. The waste tube of claim 1 wherein said inner layer is selected from polytetrafluoroethylene (PTFE) and fluorinated ethylene propylene (FEP).
